(19) United States
(12) Patent Application Publication
(10) Pub. No.: US 2010/0313106 A1
(43) Pub. Date: Dec. 9, 2010

(54) CONVERTING DIAGRAMS BETWEEN FORMATS

(75) Inventors: Adam Spencer Callens, Redmond, WA (US); Christopher Michael Becker, Redmond, WA (US); Crystal Lynn Hoyer, Seattle, WA (US); Matthew Kotler, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/477,916

(22) Filed: Jun. 4, 2009

(51) Int. Cl. G06F 17/00

(52) U.S. Cl. 715/201

(57) ABSTRACT

An instruction is received to convert a first diagram in the advanced diagram format to a second diagram in a basic diagram format. The advanced diagram format may be configured to restrict user customization. The basic diagram format may be configured to permit the user customization. When the instruction is received to convert the first diagram to the second diagram, the first diagram is converted to the second diagram by transforming shapes, text, and formatting in the first diagram into shapes, text, and formatting in the second diagram.

### BACKGROUND

Some productivity suite applications (e.g., word processing applications, spreadsheet applications, presentation applications, email applications, etc.) provide diagram functionality for creating, editing, and formatting diagrams within documents. Diagrams may provide a visual representation of information for effectively communicating messages or ideas. Diagrams may contain shapes, text, and other visuals. The diagram functionality may provide templates defined by different categories. The templates may dynamically arrange the layout and format of visuals on a document with little input from the user. In this way, multiple diagrams can be rendered in a consistent manner.

By restricting the level of input from the user, the diagram functionality can provide a more automated and user-friendly experience. In particular, the pre-defined templates may provide designer-quality illustrations without the effort or cost of a professional designer. However, more experienced users may become frustrated at the lack of ability to edit and add customizations to the pre-arranged diagrams. These customizations may include sizing and positioning the visuals within the diagrams.

It is with respect to these and other considerations that the disclosure made herein is presented.

### SUMMARY

Technologies are described herein for converting a diagram between formats. Through the utilization of the technologies and concepts presented herein, a first diagram in an advanced diagram format may be converted to (1) a second diagram in a basic diagram format and/or (2) a textual representation. The advanced diagram format may be configured to restrict certain user customizations of the first diagram. However, the basic diagram format and the textual representation may not be configured with these restrictions. Thus, by converting the first diagram into the second diagram and/or the textual representation, a user may then be able to customize the diagram and/or the textual representation without the restrictions caused by the advanced diagram format.

According to embodiments, methods are provided herein for converting a diagram between formats. According to some methods, an instruction is received to convert a first diagram in the advanced diagram format to a second diagram in a basic diagram format. The advanced diagram format may be configured to restrict user customization. The basic diagram format may be configured to permit the user customization. When the instruction is received to convert the first diagram to the second diagram, the first diagram is converted to the second diagram by transforming shapes, text, and formatting in the first diagram into shapes, text, and formatting in the second diagram.

It should also be appreciated that the above-described subject matter may also be implemented as a computer-controlled apparatus, a computer process, a computing system, or as an article of manufacture such as a computer-storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all of the disadvantages noted in any part of this disclosure.

### BRIEF DESCRIPTION OF THE DRAWINGS

FIG. 1 is a computer architecture diagram showing illustrative computer architectures configured to convert a diagram between formats, in accordance with embodiments;

FIG. 2A is a screen display diagram showing examples of user interfaces for generating and editing a diagram in an advanced diagram format, in accordance with embodiments;

FIG. 2B is a screen display diagram showing examples of user interface menus for converting the diagram in the advanced diagram format to a diagram in a basic diagram format or a textual representation, in accordance with embodiments;

FIG. 3 is a screen display diagram showing examples of user interfaces for generating and editing the diagram in the basic diagram format upon converting the diagram in the advanced diagram format to the diagram in the basic diagram format, in accordance with embodiments;

FIG. 4 is a screen display diagram showing examples of user interfaces for generating and editing the textual representation upon converting the diagram in the advanced diagram format to the textual representation, in accordance with embodiments;

FIG. 5 is a flow diagram illustrating methods for converting a diagram between formats, in accordance with embodiments;

FIG. 6 is a diagram showing examples of an original diagram, a converted diagram implementing transformations, and a converted diagram without transformations, in accordance with embodiments;

FIGS. 7A-7C is a diagram showing examples of an organizational chart in the advanced diagram format, a converted organization chart in the basic diagram format, and a converted textual representation, in accordance with embodiments; and

FIG. 8A-8C is a diagram showing examples of an organizational chart in the advanced diagram format, a converted organization chart in the basic diagram format, and a converted textual representation, in accordance with embodiments

FIG. 9 is a computer architecture diagram showing illustrative computer hardware architectures for a computing system capable of implementing the embodiments presented herein.

### DETAILED DESCRIPTION

The following detailed description is directed to technologies for converting a first diagram configured in an advanced diagram format into (1) a second diagram configured in a basic diagram format and/or (2) a textual representation. As described herein, a diagram may include a combination of shapes and text, and the textual representation may include text without the shapes. In some embodiments, a diagram may also be a collection of text in which typography and text alignment are configured and arranged to create a visual depiction. The advanced diagram format may automate various features of the first diagram including, but not limited to, controlling the size and position of the shapes and text in the first diagram. This automation, however, may restrict a user's ability to freely edit and customize the size and position of the shapes and text in the first diagram. In contrast to the advanced diagram format, the basic diagram format permits a user to edit and customize the size and position of the shapes and text in the second diagram without restriction. The textual representation also permits a user to edit and customize the size and position of the text in the textual representation without restriction.

Embodiments described herein facilitate the conversion of the first diagram in the advanced diagram format to the second diagram in the basic diagram format. Embodiments described herein further facilitate the conversion of the first diagram in the advanced diagram format to the textual representation. The converted second diagram may preserve the visual qualities and at least some of the automated features in the first diagram. The converted textual representation may also preserve the visual qualities of the text in the first diagram. Upon converting the first diagram to the second diagram and/or the textual representation, a user can freely edit and customize the second diagram and/or the textual representation without the restrictions caused by the advanced diagram format.

An example of the advanced diagram format is the SMARTART diagram format from MICROSOFT CORPORATION. The SMARTART diagram format is provided through the MICROSOFT OFFICE productivity suite also from MICROSOFT CORPORATION. An example of the basic diagram format is the drawing format, which is also provided through the MICROSOFT OFFICE productivity suite from MICROSOFT CORPORATION. Although embodiments described herein may refer to the SMARTART format and the drawing format from the MICROSOFT OFFICE productivity suite as illustrative examples, it should be appreciated that implementations of this description may operate with other diagram formats from other application programs as contemplated by those skilled in the art.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

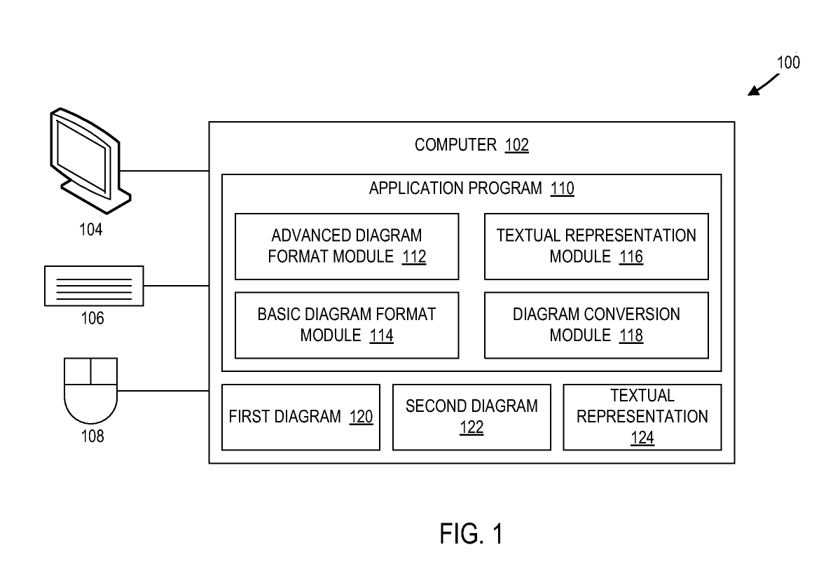

In the following detailed description, references are made to the accompanying drawings that form a part hereof, and which show specific embodiments or examples by way of illustration. Referring now to the drawings, in which like numerals represent like elements through the several figures, a computing system and methodology for converting a first diagram configured in an advanced diagram format into a second diagram configured in a basic diagram format and/or a textual representation will be described. In particular, FIG. 1 illustrates example computer architectures 100 including a computer 102 coupled to a display 104, a keyboard 106, and a mouse 108. Other input and output devices may also be coupled to the computer 102 as contemplated by those skilled in the art.

The computer 102 may be configured to execute an application program 110. In some embodiments, the application program 110 may be an application program from a productivity application suite. Examples of such application programs may include word processing applications, spreadsheet applications, presentation applications, and electronic mail applications. In other embodiments, the application program 110 may be any suitable application program configured to generate, edit, and convert diagrams as disclosed herein.

The application program 110 may include an advanced diagram format module 112, a basic diagram format module 114, a textual representation module 116, and a diagram conversion module 118. The advanced diagram format module 112 may provide an interface enabling a user to generate and edit diagrams configured in an advanced diagram format through the application program 110. An example of a diagram configured in an advanced diagram format is a first diagram 120. The basic diagram format module 114 may provide an interface enabling a user to generate and edit diagrams configured in a basic diagram format through the application program 110. An example of a diagram configured in a basic diagram format is a second diagram 122. The textual representation module 116 may provide an interface enabling a user to generate and edit textual representations, such as a textual representation 124. The diagram conversion module 118 may facilitate the conversion of the first diagram 120 in the advanced diagram format into (1) the second diagram 122 in the basic diagram format and/or (2) the textual representation 124. Additional details regarding the advanced diagram format and the basic diagram format are provided below.

The advanced diagram format may include a variety of automated features that simplify the visuals and layout of the first diagram 120. The advanced diagram format module 112 may implement these automated features with little or no input from the user. A non-limiting example of the advanced diagram format is the SMARTART diagram format from MICROSOFT CORPORATION. It should be appreciated that the automated features described herein are merely illustrative and are not intended to be limiting. Other automated features may be similarly implemented as contemplated by those skilled in the art.

In some embodiments, the advanced diagram format may include an invisible border in which the first diagram 120 is placed. As additional shapes and text are added to the first diagram 120 and as shapes and text are removed from the first diagram 120, the advanced diagram format module 112 may reposition, resize, and/or realign the shapes and text in order to fit the shapes and text within the border. For example, the first diagram 120 may initially have three shapes that fill the border along with associated text that is positioned inside each of the shapes. As the user adds additional shapes into the first diagram 120, the advanced diagram format module 112 may reduce the size of the current shapes and associated text in order to maintain the additional shapes within the border and to maintain the associated text within the shapes.

In additional embodiments, the advanced diagram format may include a theme that is applied across a diagram. The advanced diagram format module 112 may provide a selection of predefined themes, and a user may also design custom themes. A theme may specify various visuals of the shapes (referred to herein as “shape visuals”), such as color fills, border colors, reflections, and shadows. A theme may also specify various visuals of the text (referred to herein as “text visuals”), such as text color, font, and text effects (e.g., bold, italic, glow, reflection, etc.). As a user adds shapes and text, the advanced diagram format module 112 may adjust the visuals of the shapes and text in the first diagram 120 to correspond to the theme. As used herein, a diagram configured to be adjusted according to a theme may be referred to as being theme-aware or having theme-aware functionality.

In yet additional embodiments, the advanced diagram format may be configured such that shapes and text are separately created and positioned, whereas the basic diagram format may be configured such that shapes and text are tied together. That is, in the first diagram 120 configured in the advanced diagram format, a user can create a shape and position it within the first diagram 120; at a different time, the user can create text and position it within the first diagram 120. In contrast, in the second diagram 122 configured in the basic diagram format, a user may be restricted to creating and positioning the text and the shape at the same time. In this case, the user may not be able to position the text apart from the position of the text.

For example, consider a shape and associated text within or near the shape. The shape and the associated text are contained in the first diagram 120 in the advanced diagram format and in the second diagram 122 in the basic diagram format. While editing the first diagram 120, the advanced diagram format module 112 may be configured to maintain the text in a horizontal position even when the shape is rotated away from a horizontal position. Thus, if the shape and the text are initially positioned at zero degrees and if the shape is then rotated at ninety degrees, the text remains at zero degrees even though the shape is now positioned at ninety degrees. Because the shape and the text are separately positioned in the advanced diagram format, the advanced diagram format module 112 is capable of positioning the shape and the text differently.

The basic diagram format may exclude a portion or all of the automated features provided by the advanced diagram format. Because the basic diagram format module 114 may exclude at least some of the automated features provided by the advanced diagram format, the user has greater freedom to customize the second diagram 122 in the basic diagram format versus the first diagram 120 in the advanced diagram format. That is, in some implementation scenarios, the automated features are not present to override the user customizations. A non-limiting example of the basic diagram format is the AUTOSHAPES format provided through the MICROSOFT OFFICE productivity suite from MICROSOFT CORPORATION.

According to some embodiments, the basic diagram format may exclude the invisible border or the theme-aware functionality provided by the advanced diagram format. Further, in contrast to the advanced diagram format, while editing the second diagram 122 in the basic diagram format, the basic diagram format module 114 may be configured to maintain the text in the same position relative to the shape. In an example, if the shape and the text are initially positioned at zero degrees and if the shape is rotated ninety degrees, the text is also rotated ninety degrees. In another example, if the shape and the text are initially positioned in a first orientation and if the shape is reflected (i.e., a mirror image of the shape is created), then the text is also reflected (i.e., a mirror image of the text is also created). Because the shape and the associated text are tied together in the basic diagram format, the basic diagram format module 114 may not support positioning the shape and text differently.

By automating certain features in the advanced diagram format, a user can spend less time on manual and tedious layout tasks, such as adjusting the size of shapes so that the shapes are the same size, repositioning the shapes so that the shapes align along an axis, and formatting the shapes to match an overall style. However, according to some embodiments, the advanced diagram format module 112 may restrict the amount of user customization that can be performed on the first diagram 120 in the advanced diagram format. For example, the advanced diagram format module 112 may restrict whether the user can adjust the position of a shape outside a given alignment, resize a shape such that it does not match other shapes in the diagram, or change the color fill of a given shape in conflict with a theme.

In order to customize a diagram in the advanced diagram format, a user may utilize an interface provided by the diagram conversion module 118 to convert the first diagram 120 in the advanced diagram format into (1) the second diagram 122 in the basic diagram format and/or (2) the textual representation 124. Upon completing the conversion, the user may customize the second diagram 122 or the textual representation 124 as desired without the restrictions associated with some or all of the automated features in the first diagram 120.

The diagram conversion module 118 may perform one or more transformations in order to convert the first diagram 120 in the advanced diagram format to the second diagram 122 in the basic diagram format or the textual representation 124. In particular, the diagram conversion module 118 may be configured to preserve the visual fidelity of the first diagram 120 during the conversion process. The diagram conversion module 118 may also be configured to preserve at least some functional fidelity in the first diagram 120 during the conversion process.

If the first diagram 120 is converted to the second diagram 122, then the diagram conversion module 118 may preserve the visual fidelity of shapes and text. That is, the shapes and text contained in the second diagram 122 may be visually identical or substantially visually identical to the shapes and text contained in the first diagram 120. In some embodiments, the diagram conversion module 118 may also preserve custom animations included within the first diagram 120. If the first diagram 120 is converted to the textual representation 124, then the diagram conversion module 118 may preserve the visual fidelity of text. That is, the text contained in the textual representation 124 may be visually identical or substantially visually identical to the text in the first diagram 120.

The visual fidelity may include the position of the shapes and text, the size of the shapes and text, the shape visuals, and the text visuals. In some embodiments, the diagram conversion module 118 may preserve the position of the shapes and text by utilizing a matrix transformation and other suitable geometric transformation techniques. The visual fidelity may also include the hierarchy of the text in the first diagram 120 when the first diagram 120 is converted into second diagram 122. For example, the first diagram 120 may be an organizational chart or other diagram specifying a structure of components and relationships between the components (e.g., component A may include sub-components B and C, while component D may include sub-components E and F). When the first diagram 120 is converted into text, the text may be a bulleted list or numbered list that preserves the relationships of the components specified by the organizational chart. The bulleted list or numbered list may preserve the relationships of components by indenting the sub-components or changing the numbering of the subcomponents.

The functional fidelity may include the theme-aware functionality of the advanced diagram format. In some embodiments, the diagram conversion module 118 may perform the theme-aware functionality on the diagram in the basic diagram format because the basic diagram format does not natively provide the theme-aware functionality. Any additional functionality provided in the advanced diagram format may be implemented by the diagram conversion module 118 to supplement the native functionality, if any, of the basic diagram format.

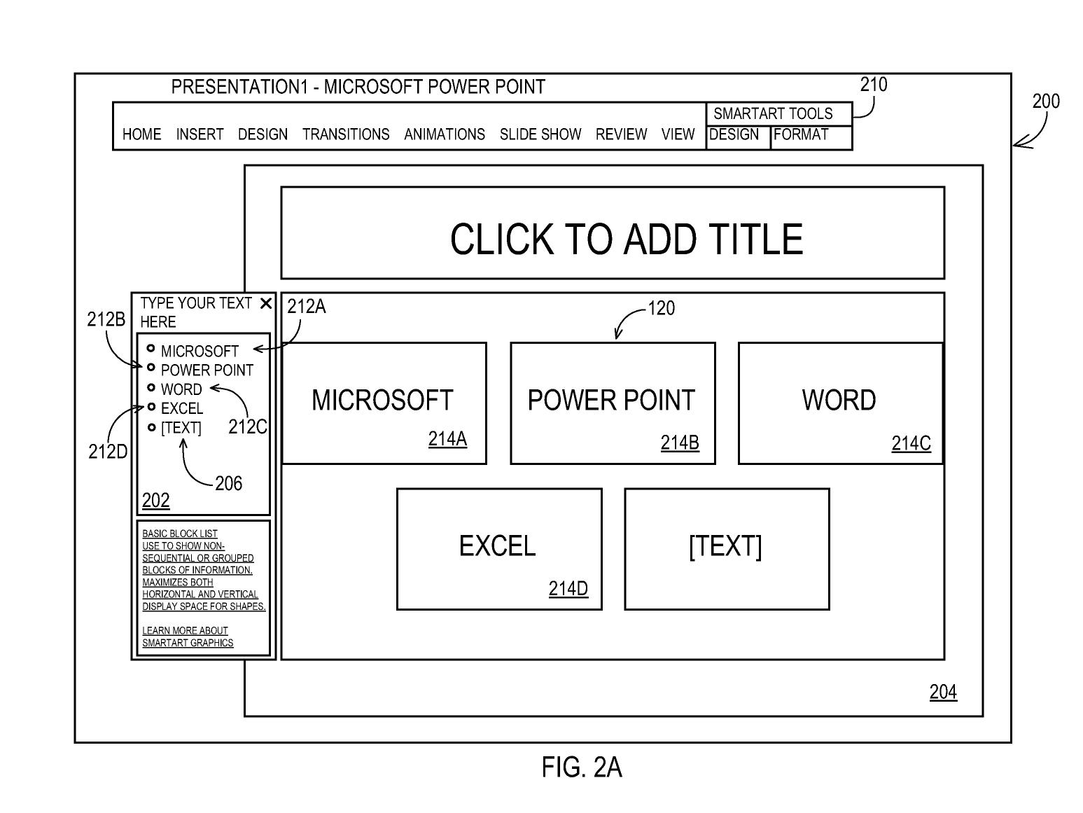

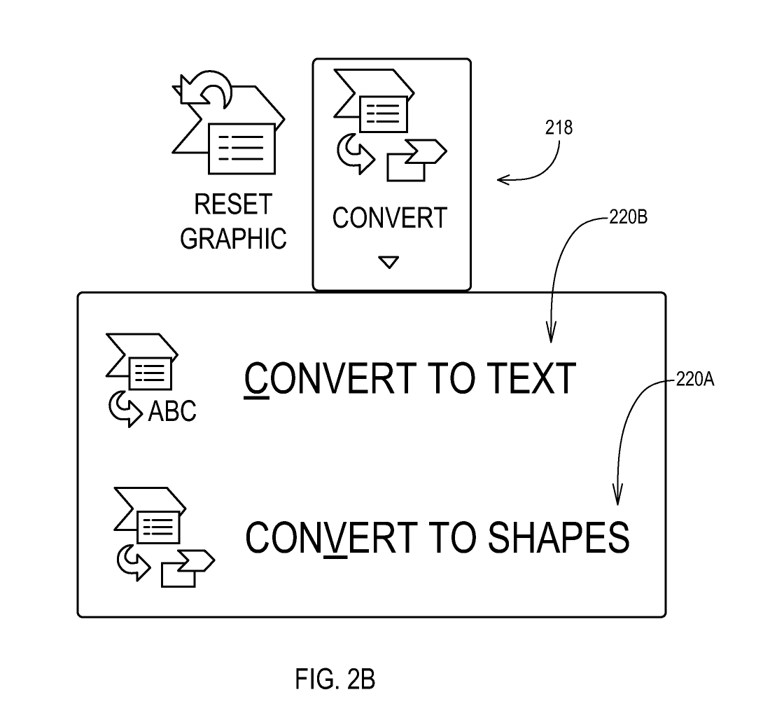

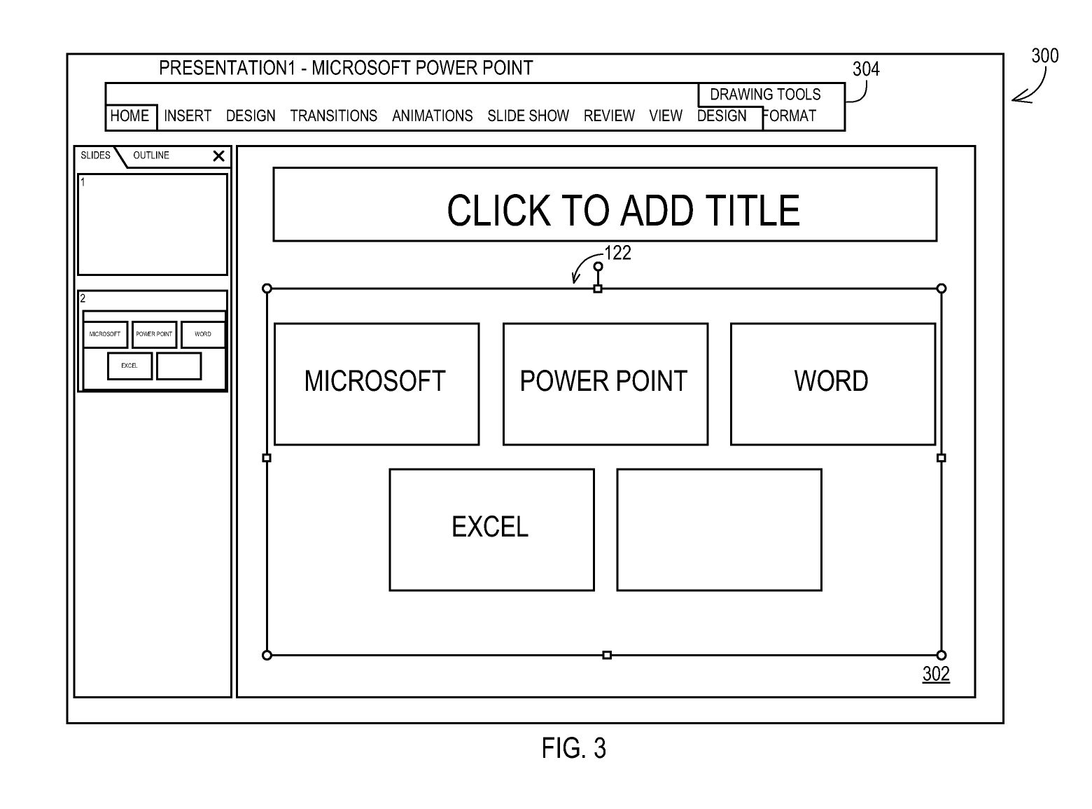

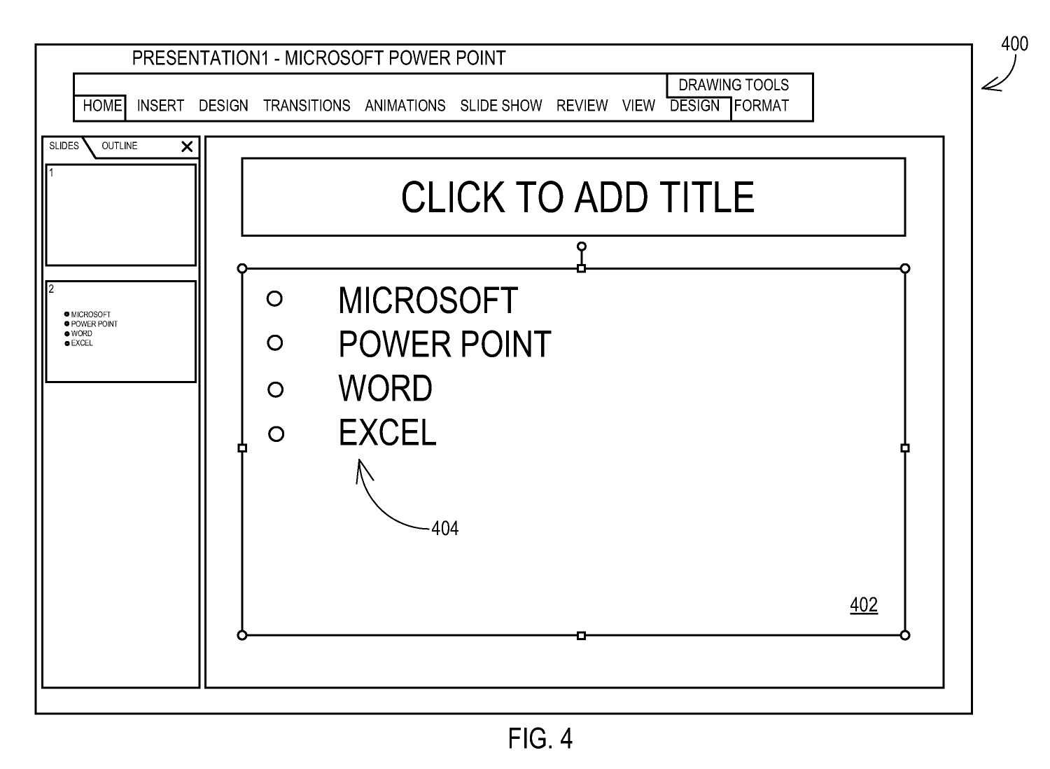

Referring now to FIGS. 2A, 2B, 3, and 4, additional details regarding user interfaces provided by the application program 110, and in particular, by the advanced diagram format module 112, the basic diagram format module 114, the textual representation module 116, and the diagram conversion module 118, will be described. In particular, FIG. 2A is a screen display diagram showing user interfaces for creating the first diagram 120, according to embodiments. FIG. 2B is a screen display diagram showing additional details regarding conversion selection menus illustrated in FIG. 2A, according to embodiments. FIG. 3 is a screen display diagram showing user interfaces upon converting the first diagram 120 to the second diagram 122. FIG. 4 is a screen display diagram showing user interfaces upon converting the first diagram 120 to the textual representation 124.

As illustrated in FIG. 2A, representative user interfaces 200 may include a text pane 202 and a content pane 204. The text pane 202 may include a bulleted list 206 as entered by a user. The content pane 204 may include the first diagram 120 corresponding to the bulleted list 206. As the user enters items into the bulleted list 206, the advanced diagram format module 112 may generate or edit the first diagram 120 corresponding to the bulleted list 206. The user interfaces 200 may further include an advanced diagram format ribbon 210 containing various user-selectable functions that can be performed on the first diagram 120.

The bulleted list 206 may include a first item 212A, a second item 212B, a third item 212C, and a fourth item 212D (collectively referred to as items 212). The first diagram 120 may include a first shape 214A, a second shape 214B, a third shape 214C, and a fourth shape 214D (collectively referred to as shapes 214). The first item 212A, the second item 212B, the third item 212C, and the fourth item 212D correspond to the first shape 214A, the second shape 214B, the third shape 214C, and the fourth shape 214D, respectively.

Although the bulleted list 206 shown in FIG. 2 does not show relationships between the items 212, it should be appreciated that in some implementations of this description, the bulleted list 206 may show relationships between the items 212. For example, the second item 212B, the third item 212C, and the fourth item 212D may be indented under the first item 212A in order to indicate that the second item 212B, the third item 212C, and the fourth item 212D are subcomponents of the first item 212A. In this case, the advanced diagram format module 112 may add connections between the shapes 214 and/or align the shapes 214 in a certain layout in order show relationships between the items 212. In correspondence with the previous example, the first shape 214A may be independently connected to the second shape 214B, the third shape 214C, and the fourth shape 214D. Further, the second shape 214B, the third shape 214C, and the fourth shape 214D may be positioned under the first shape 214A. In this way, the connections from the first shape 214A to the second shape 214B, the third shape 214C, and the fourth shape 214D and the position of the shapes 214 provide a graphical visualization of the relations between the items 212 shown in the bulleted list 206.

Because the first diagram 120 is in the advanced diagram format, the first diagram 120 may include various automated features, as previously described. These automated features may restrict the user's ability to customize the first diagram 120 if the user customizations conflict with the automated features. In order to circumvent the customization restrictions inherent in the advanced diagram format, a user may convert the first diagram 120 into the second diagram 122 in the basic diagram format or the textual representation 124 (both of which are shown in FIG. 1). In particular, the user may access a conversion selection menu 218, which is described in greater detail below with respect to FIG. 2B.

As illustrated in FIG. 2B, the conversion selection menu 218 may expand upon the user accessing the conversion selection menu 218. For example, the user may access the conversion selection menu 218 by left-clicking the mouse 108 (FIG. 1) when a mouse pointer (not shown) is positioned over the conversion selection menu 218. Other mechanisms for accessing the conversion selection menu 218 may be similarly implemented. The conversion selection menu 218 when expanded may include a convert-to-shapes option 220A and a convert-to-text option 220B. If the convert-to-shapes option 220A is selected, the diagram conversion module 118 may convert the first diagram 120 to the second diagram 122, as illustrated in FIG. 3. If the convert-to-text option 220B is selected, the diagram conversion module 118 may convert the first diagram 120 to the textual representation 124, as illustrated in FIG. 4.

As illustrated in FIG. 3, representative user interfaces 300 may include a content pane 302 that contains the second diagram 122 in a basic diagram format. The second diagram 122 may represent the output from the diagram conversion module 118 after the user selects the convert-to-shapes option 220A. The user interfaces 300 may further include a basic diagram format ribbon 304 containing various user-selectable functions that can be performed on the second diagram 122. The basic diagram format may exclude at least some of the automated features provided by the advanced diagram format. As a result, a user may have greater flexibility to customize the second diagram 122 in the basic diagram format, as compared to the first diagram 120 in the advanced diagram format.

According to some embodiments, the visual fidelity of the first diagram 120 in the advanced diagram format may be preserved in the second diagram 122 in the basic diagram format. That is, the second diagram 122 may be visually identical or substantially visually identical to the first diagram 120. For example, the first diagram 120 and the second diagram 122 may contain the same shape position, shape size, text position, text size, shape visuals, text visuals, and the like. In some embodiments, the diagram conversion module 118 may implement theme-aware functionality provided in the advanced diagram format because the basic diagram format may not natively provide the theme-aware functionality.

In some embodiments, the user interfaces 300 may include a group and ungroup functionality. By “grouping” shapes through the user interfaces 300, a user can perform actions on multiple shapes at the same time. For example, the user can move the group of shapes, size the shapes, rotate the shapes, align the shapes, and the like. When the user desires to perform actions on individual shapes again, the user can “ungroup” the group of shapes. For example, after ungrouping the group of shapes, the user can move individual shapes, size individual shapes, rotate individual shapes, align individual shapes, and the like.

As illustrated in FIG. 4, representative user interfaces 400 may include a text pane 402 that contains a textual representation 404 of content from the first diagram 120 containing shapes and text. The textual representation 404 may include a bulleted list or other representation that contains the text but not the shapes in the first diagram 120 in the advanced diagram format. According to embodiments, the textual representation 404 may be visually identical or substantially visually identical to the text in the first diagram 120. That is, the text in the textual representation 124 may have the same text size and the same text visuals as the text in the first diagram 120. As previously described, the text in the textual representation 124 may also preserve the hierarchy specified by the shapes and text in the first diagram 120.

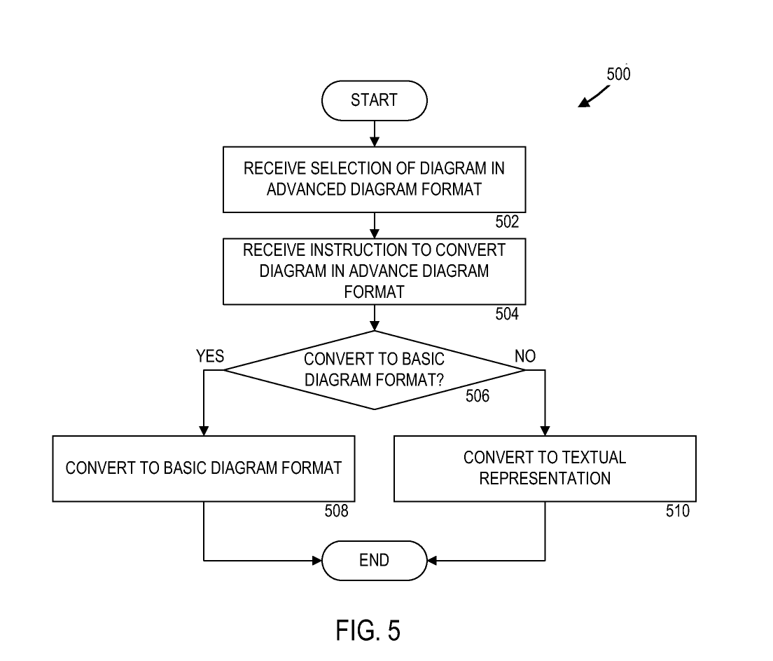

Referring now to FIG. 5, additional details regarding the operation of the diagram conversion module 118 will be described. In particular, FIG. 5 shows a flow diagram illustrating methods for converting the first diagram 120 in the advanced diagram format to the second diagram 122 in the basic diagram format or the textual representation 124, according to embodiments.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 5, representative routines 500 may begin at operation 502, where the diagram conversion module 118 may receive a selection of the first diagram 120 in the advanced diagram format. For example, a user may select at least a portion of the first diagram 120 utilizing a suitable input device, such as the keyboard 106 or the mouse 108 discussed above in FIG. 1. When the diagram conversion module 118 receives the selection of the first diagram 120, the routine 500 proceeds to operation 504, where the diagram conversion module 118 may receive an instruction to convert the first diagram 120. For example, a user may select the convert-to-shapes option 220A to instruct the diagram conversion module 118 to convert the first diagram 120 to the second diagram 122. Further, a user may select the convert-to-text option 220B to instruct the diagram conversion module 118 to convert the first diagram 120 to the textual representation 124. When the diagram conversion module 118 receives the instruction, the routine 500 proceeds to operation 506.

At operation 506, the diagram conversion module 118 determines whether the instruction specifies a conversion of the first diagram 120 to the basic diagram format or to the textual representation. If the instruction specifies a conversion to the basic diagram format, then the routine 500 proceeds to operation 508. If the instruction specifies a conversion to the textual representation, then the routine 500 proceeds to operation 510.

At operation 508, the diagram conversion module 118 may convert the first diagram 120 to the second diagram 122. When converting the first diagram 120 to the second diagram 122, the diagram conversion module 118 may maintain in the second diagram 122 at least some of the formatting characteristics found in the first diagram 120. These formatting characteristics may include, but are not limited to, rotation of the shapes, position of shapes and text, and the application of themes. At operation 510, the diagram conversion module 118 may convert the first diagram 120 to the textual representation 124. When converting the first diagram 120 to the textual representation 124, the diagram conversion module 118 may maintain in the textual representation 124 at least some of the formatting characteristics found in the first diagram 120. These formatting characteristics may include, but are not limited to, fonts utilized by the text and hierarchy of the text.

Upon converting the first diagram 120 to the second diagram 122 or to the textual representation 124, a user may customize without the restrictions of the advanced diagram format. For example, if the advanced diagram format restricts user customization of the size and position of shapes and text, the basic diagram format may not restrict user customization of the size and position shapes and text. Further, the textual representation may not restrict user customization of the size and position of text.

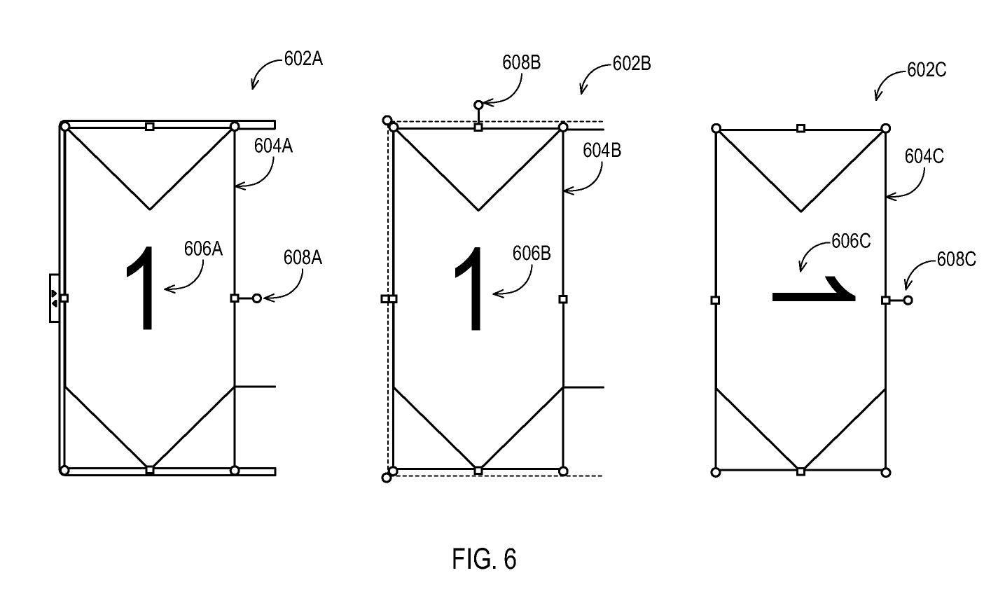

Referring now to FIG. 6, additional details regarding the diagram conversion module 118 will be described. Shapes in Office Open XML (“OOXML”) may not define a way for text to have a separate transform apart from the shape associated with the text. In some embodiments, the advanced diagram format may create a first shape for text and a second shape for shape formatting. The first shape may have no fill (i.e., a clear background) such that the first shape can float on top of the second shape. The advanced diagram format module 112 may display the first shape and the second shape as a single shape for the user. When converting the first diagram 120 in the advanced diagram format to the second diagram 122 in the basic diagram format, the diagram conversion module 118 may merge the first and second shapes into a single shape by transforming the path of the second shape to be the orientation relative to the first shape.

In FIG. 6, three diagrams 602A, 602B, and 602C are shown. The first diagram 602A is in the advanced diagram format. The first diagram 602A includes a shape 604A and text 606A. As previously described, in the advanced diagram format, the shape 604A and the text 606A may be oriented differently. An indicator 608A indicates the top of the shape 604A. The text 606A has been rotated ninety degrees relative to the top of the shape 604A.

The second diagram 602B is in the basic diagram format. The second diagram 602B includes a shape 604B and text 606B. As previously described, in the basic diagram format, the shape 604B and the text 606B are oriented together. That is, the text 606B is positioned relative to the top of the shape 604B. As such, the diagram conversion module 118 may align the top of the shape 604B to the text 606B, as illustrated by an indicator 608B. Further, the geometry of the shape 604B has been rotated ninety degree to match the orientation of the shape 604A.

The third diagram 602C is in the basic diagram format without the transformations performed by the diagram conversion module 118. The third diagram 602C includes a shape 604C and text 606C. An indicator 608C indicates the top of the shape 604C. The position of the indicator 608C is the same as the indicator 608A. The text 606C is positioned relative to the top of the shape 604C. While the positioning of the shape 604C is the same as the shape 604A, the positioning of the text 606C differs from the text 606A due to the restrictions of the basic diagram format.

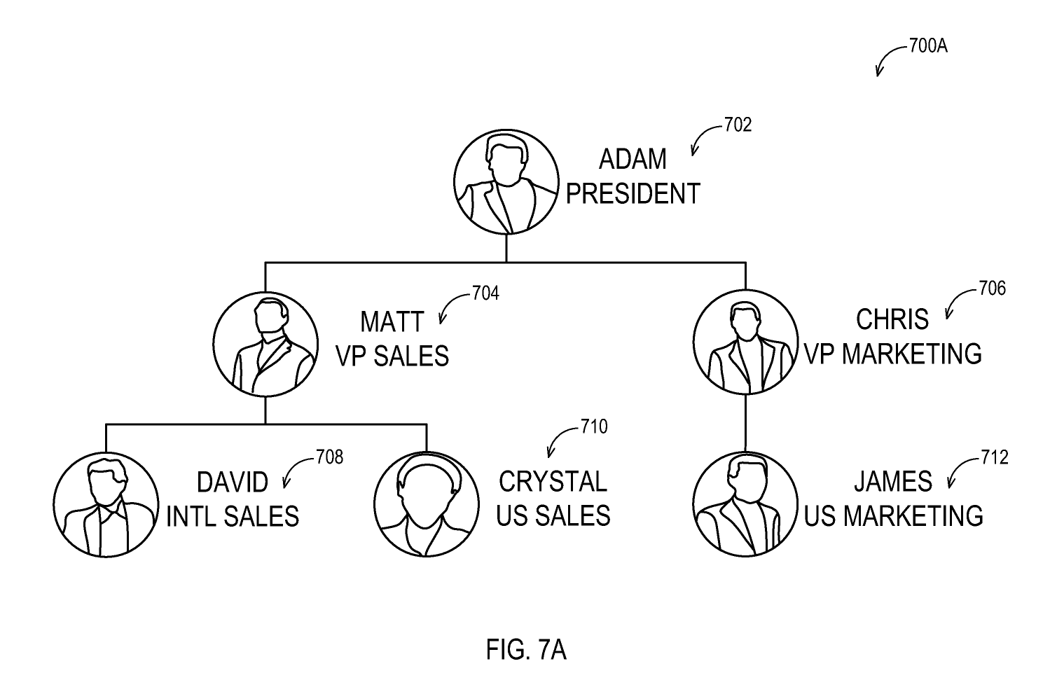

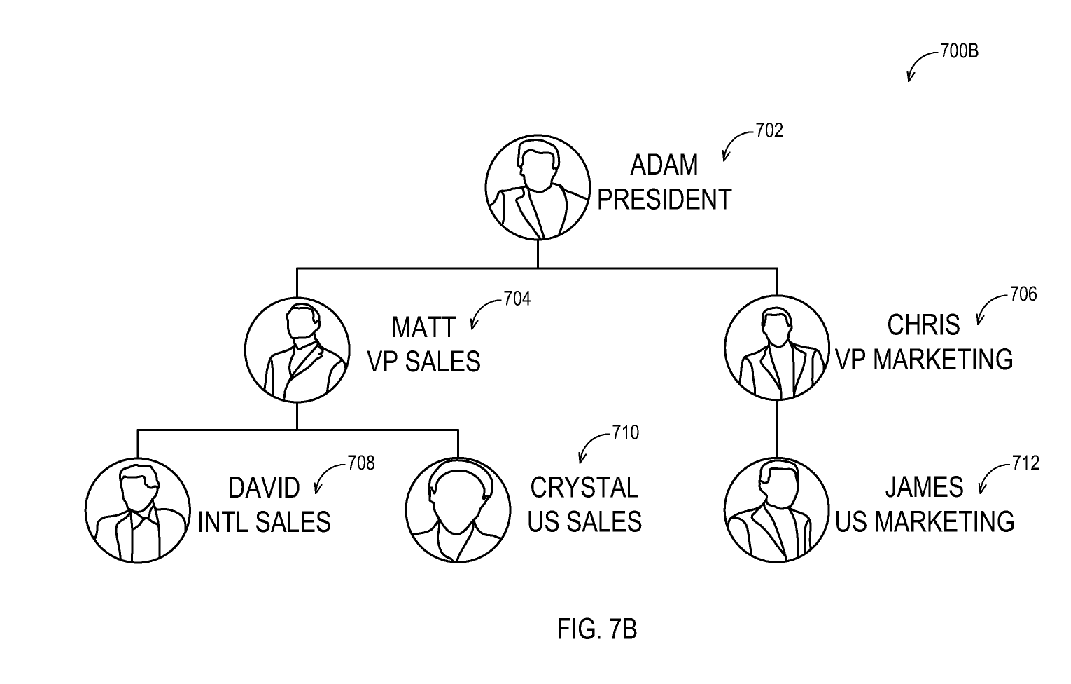

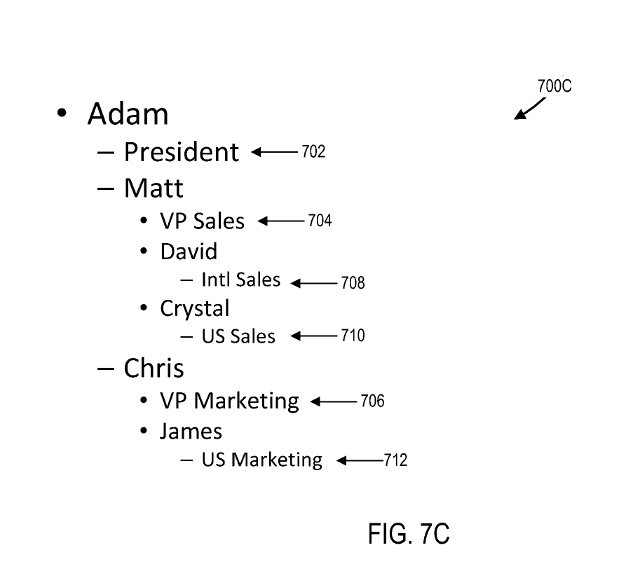

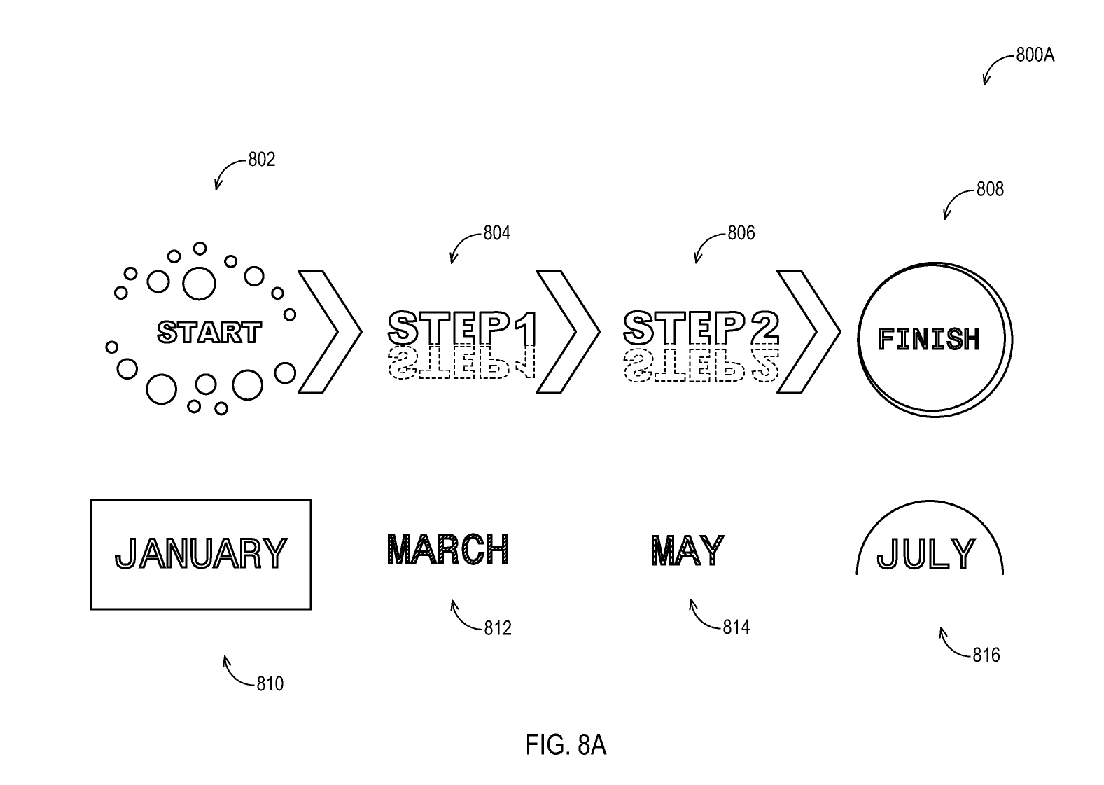

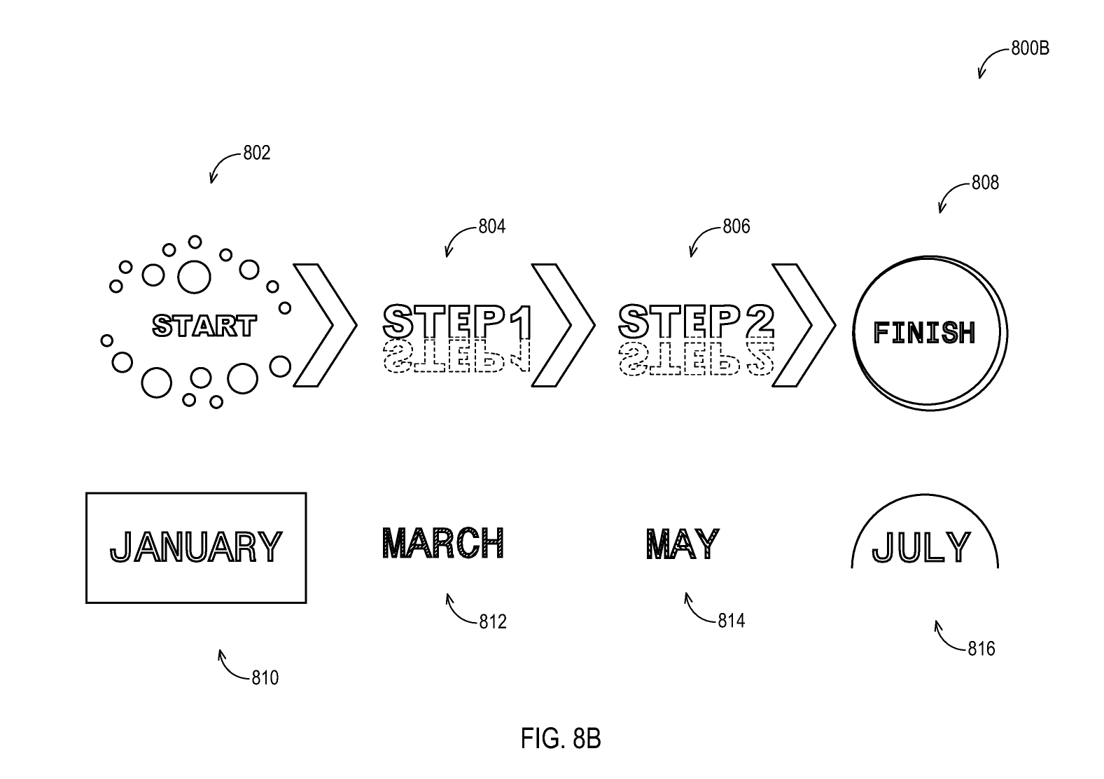

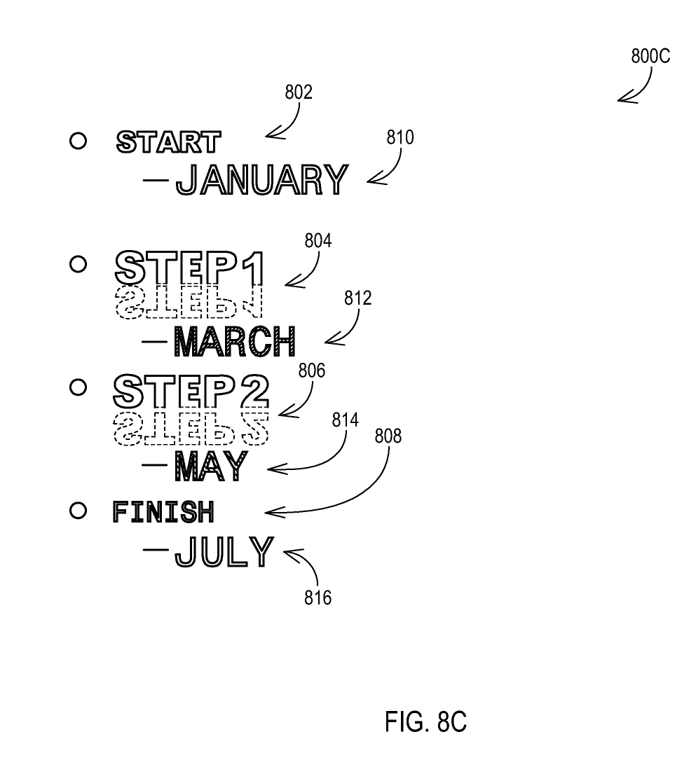

Referring now to FIGS. 7A-7C and 8A-8C, additional details regarding conversion of the first diagram 120 in the advanced diagram format to the second diagram 122 in the basic diagram format and the textual representation 124 will be described. In particular, FIG. 7A illustrates an organizational chart 700A in the advanced diagram format. The diagram conversion module 118 converts the organizational chart 700A to an organizational chart 700B in the basic diagram format, as illustrated in FIG. 7B. The diagram conversion module 118 also coverts the organizational chart 700A to a textual representation 700C as illustrated in FIG. 7C. FIG. 8A illustrates a scheduling diagram 800A in the advanced diagram format. The diagram conversion module 118 converts the scheduling diagram 800A to a scheduling diagram 800B in the basic diagram format, as illustrated in FIG. 8B. The diagram conversion module 118 also coverts the scheduling diagram 800A to a textual representation 800C as illustrated in FIG. 8C.

In FIG. 7A, the organizational chart 700A specifies a hierarchy of management within a company. At the top of the organizational chart 700A is a president 702. At a level below the president 702 are a vice president of sales 704, and a vice president of marketing 706. Below the vice president of sales 704 are a head of international sales 708 and a head of U.S. sales 710. Below the vice president of marketing 706 is a head of U.S. marketing 712.

In FIG. 7B, the organizational chart 700B maintains the same images, text, and hierarchy found in the organizational chart 700A. FIG. 7C, the textual representation 700C does not include the images found in the organizational charts 700A, 700B, but does include the text and hierarchy. In the organizational charts 700A, 700B, the hierarchy is visually illustrated in a tree. In contrast, in the textual representation 700C, the hierarchy is visually illustrated as an outline. Like the organizational charts 700A, 700B, the textual representation 700C specifies the president 702 at the top of the hierarchy. Below the president 702 are the vice president of sales 704 and the vice president of marketing 706. Below the vice president of sales 704 are the head of international sales 708 and the head of U.S. sales 710. Below the vice president of marketing 706 is the head of U.S. marketing 712. Although not so illustrated in FIGS. 7A-7C, the organizational chart 700B and the textual representation 700C may also maintain the theme associated with the organizational chart 700A.

In FIG. 8A, the scheduling diagram 800A includes a start element 802, a first step 804, a second step 806, and a finish element 808. The start element is scheduled for January 810, and the first step 804 is schedule for March 812. The second step 806 is schedule for May 814, and the finish element is scheduled for July 816. Each of the elements 802-816 in the scheduling diagram 800A has a formatting applied to the text in terms of fonts, graphics, colors, and the like. The elements 802-816 also include some images around the text. In FIG. 8B, the scheduling diagram 800B maintains the same images, text, and formatting found in the organizational chart 700A. In FIG. 8C, the textual representation 800C contains much of the same fonts, effects, and colors, although the images have been removed. Although not so illustrated in FIGS. 8A-8C, the scheduling diagram 800B and the textual representation 800C may also maintain the theme associated with the scheduling diagram 800A.

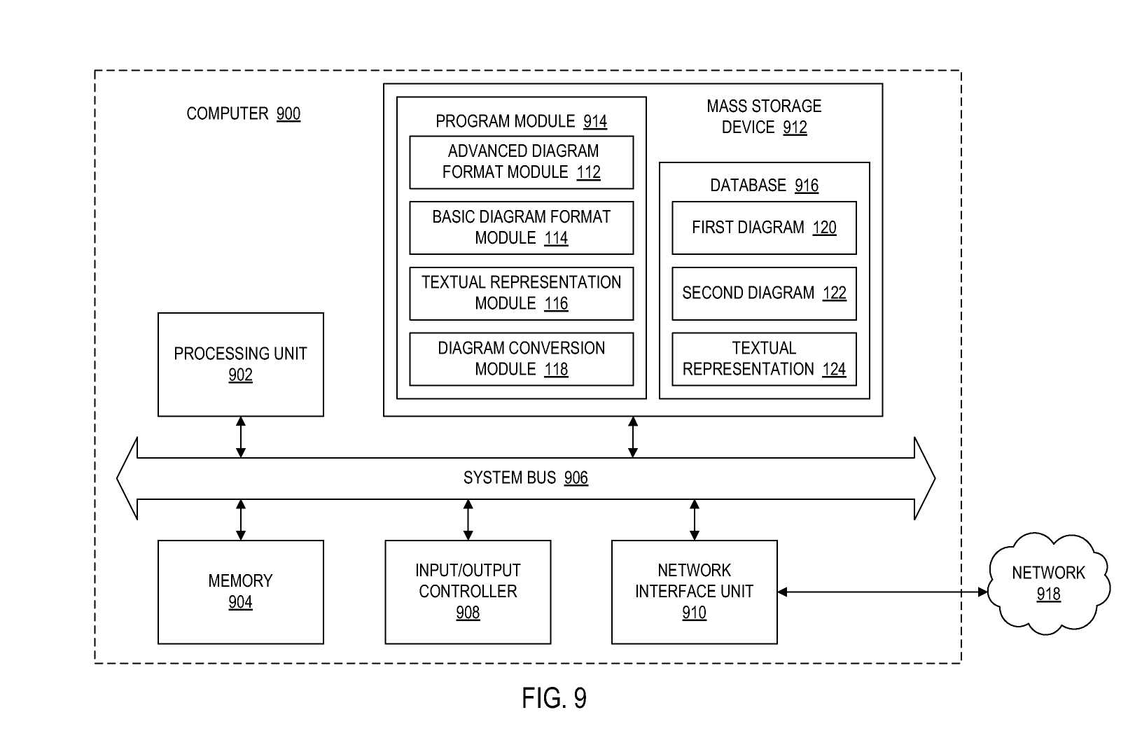

Referring now to FIG. 9, an example computer architecture diagram showing a computer 900 is illustrated. An example of the computer 900 may include the computer 102 of FIG. 1. The computer 900 includes a processing unit 902 (“CPU”), a system memory 904, and a system bus 906 that couples the memory 904 to the CPU 902. The computer 900 further includes a mass storage device 912 for storing one or more program modules 914 and one or more databases 916. Examples of the program modules 914 include the advanced diagram format module 112, the basic diagram format module 114, the textual representation module 116, and the diagram conversion module 118. The databases 916 may be configured to store the first diagram 120, the second diagram 122, and the textual representation 124. The mass storage device 912 is connected to the CPU 902 through a mass storage controller (not shown) connected to the bus 906. The mass storage device 912 and its associated computer-storage media provide non-volatile storage for the computer 900. Although the description of computer-storage media contained herein refers to a mass storage device, such as a hard disk or CD-ROM drive, it should be appreciated by those skilled in the art that computer-storage media can be any available computer storage media that can be accessed by the computer 900.

By way of example, and not limitation, computer-storage media may include volatile and non-volatile, removable and non-removable media implemented in any method or technology for storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 900.

According to various embodiments, the computer 900 may operate in a networked environment using logical connections to remote computers through a network 918. The computer 900 may connect to the network 918 through a network interface unit 910 connected to the bus 906. It should be appreciated that the network interface unit 910 may also be utilized to connect to other types of networks and remote computer systems. The computer 900 may also include an input/output controller 908 for receiving and processing input from a number of input devices, including the keyboard 106, the mouse 108, a microphone, and a game controller. Similarly, the input/output controller 908 may provide output to a display or other type of output device (not shown).

The bus 906 may enable the processing unit 902 to read code and/or data to/from the mass storage device 912 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 914 may include software instructions that, when loaded into the processing unit 902 and executed, cause the computer 900 to convert a diagram between formats. The program modules 914 may also provide various tools or techniques by which the computer 900 may participate within the overall systems or operating environments using the components, flows, and data structures discussed throughout this description. For example, the program modules 914 may implement interfaces for converting a diagram between formats.

In general, the program modules 914 may, when loaded into the processing unit 902 and executed, transform the processing unit 902 and the overall computer 900 from a general-purpose computing system into a special-purpose computing system customized to convert a diagram between formats. The processing unit 902 may be constructed from any number of transistors or other discrete circuit elements, which may individually or collectively assume any number of states. More specifically, the processing unit 902 may operate as a finite-state machine, in response to executable instructions contained within the program modules 914. These computer-executable instructions may transform the processing unit 902 by specifying how the processing unit 902 transitions between states, thereby transforming the transistors or other discrete hardware elements constituting the processing unit 902.

Encoding the program modules 914 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 914 may transform the physical state of the semiconductor memory, when the software is encoded therein. For example, the program modules 914 may transform the state of transistors, capacitors, or other discrete circuit elements constituting the semiconductor memory.

As another example, the computer-storage media may be implemented using magnetic or optical technology. In such implementations, the program modules 914 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for converting a diagram between formats are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for converting a diagram between formats, the computer-implemented method comprising computer-implemented operations for:
receiving an instruction to convert a first diagram in an advanced diagram format to a second diagram in a basic diagram format, the advanced diagram format configured to restrict user customization, the basic diagram format configured to permit the user customization; and
upon receiving the instruction to convert the first diagram to the second diagram, converting the first diagram to the second diagram by transforming shapes and text in the first diagram into shapes, text, and formatting in the second diagram.

2. The computer-implemented method of claim 1, the computer-implemented method comprising computer-implemented operations for:
receiving an instruction to convert the first diagram in the advanced diagram format into a textual representation; and
upon receiving the instruction to convert the first diagram to the textual representation, converting the first diagram to the textual representation by transforming shapes and text in the first diagram to text in the textual representation.

3. The computer-implemented method of claim 2, wherein the text in the textual representation and the text in the first diagram comprise the same text visuals.

4. The computer-implemented method of claim 2, wherein the advanced diagram format is configured to restrict user customization of size and position of the shapes and the text in the first diagram; and wherein the textual representation is configured to permit user customization of the size and the position of the text in the textual representation.

5. The computer-implemented method of claim 2, wherein the textual representation comprises a bulleted list.

6. The computer-implemented method of claim 1, wherein the shapes in the second diagram and the shapes in the first diagram comprise the same shape visuals; and wherein the text in the second diagram and the text in the first diagram comprise the same text visuals.

7. The computer-implemented method of claim 1, wherein the advanced diagram format is configured to restrict user customization of size and position of the shapes and the text in the first diagram; and wherein the basic diagram format is configured to permit user customization of the size and the position of the shapes and the text in the second diagram.

8. The computer-implemented method of claim 1, wherein the advanced diagram format comprises SMARTART diagram format; and wherein the basic diagram format comprises AUTOSHAPES diagram format.

9. The computer-implemented method of claim 1, wherein the advanced diagram format is configured with theme-aware functionality; and wherein the basic diagram format is not configured with theme-aware functionality.

10. The computer-implemented method of claim 1, the computer-implemented method comprising computer-implemented operations for providing theme-aware functionality to the second diagram.

11. A computer system, comprising:
a processor;
a memory operatively coupled to the processor; and
a program module (i) which executes in the processor from the memory and (ii) which, when executed by the processor, causes the computer system to convert a diagram between formats by
receiving a first instruction to convert a first diagram in an advanced diagram format to a second diagram in a basic diagram format, the advanced diagram format configured to restrict user customization, the basic diagram format configured to permit the user customization,
upon receiving the first instruction to convert the first diagram to the second diagram, converting the first diagram to the second diagram by transforming shapes and text in the first diagram into shapes, text, and formatting in the second diagram,
receiving a second instruction to convert the first diagram in the advanced diagram format to a textual representation, and
upon receiving the second instruction to convert the first diagram to the textual representation, converting the first diagram to the textual representation by transforming shapes and text in the first diagram to text in the textual representation.

12. The computer system of claim 11, wherein the shapes and text in the first diagram are visually identical to the shapes and text in the second diagram.

13. The computer system of claim 11, wherein the text in the first diagram is visually identical to the text in the textual representation.

14. The computer system of claim 11, wherein the advanced diagram format is configured to restrict user customization of size and position of the shapes and the text in the first diagram; wherein the basic diagram format is configured to permit user customization of the size and the position of the shapes and the text in the second diagram; and wherein the textual representation is configured to permit user customization of the size and the position of the text in the textual representation.

15. The computer system of claim 11, wherein the advanced diagram format comprises SMARTART diagram format; and wherein the basic diagram format comprises AUTOSHAPES diagram format.

16. The computer system of claim 11, wherein the advanced diagram format is configured with theme-aware functionality, the theme-aware functionality configured to adjust color, font, and text visuals of a diagram as specified by a theme; and wherein the basic diagram format is not configured with theme-aware functionality.

17. The computer system of claim 16, wherein the program module, when executed by the processor, further causes the computer system to convert a diagram between formats by providing external theme-aware functionality to the second diagram apart from the basic diagram format.

18. The computer system of claim 11, wherein the program module comprises at least one of a word processing application program, a spreadsheet application program, a presentation application program, or an electronic mail application program.

19. A computer-storage medium having computer-executable instructions stored thereon which, when executed by a computer, cause the computer to:
receive a selection of a first diagram in an advanced diagram format;
when the selection of the first diagram is received, receive a selection of a first option or a second option, the first option comprising an instruction to convert the first diagram in the advanced diagram format to a second diagram in a basic diagram format, the second option comprising an instruction to convert the first diagram in the advanced diagram format into a textual representation, the advanced diagram format configured to restrict user customization of size and position of shapes and text in the first diagram, the basic diagram format configured to permit the user customization of size and position of shapes and text in the second diagram;
when the selection of the first option is received, convert the first diagram to the second diagram by transforming shapes and text in the first diagram into shapes and text in the second diagram; and
when the selection of the second option is received, convert the first diagram to the textual representation by transforming shapes, text, and formatting in the first diagram to text in the textual representation.

20. The computer-storage medium of claim 19, wherein the shapes and text in the first diagram are visually identical to the shapes and text in the second diagram; wherein the text in the first diagram is visually identical to the text in the textual representation; and wherein the text in the text representation preserves a hierarchy specified by the shapes in the first diagram.
